(19) United States
(12) Patent Application Publication
(10) Pub. No.: US 2026/0292098 A1
(43) Pub. Date: Sep. 24, 2026

(54) COMPRESSED-DOMAIN HIGH-RESOLUTION SLOW MOTION VIDEO PROCESSING

(71) Applicant: Samsung Electronics Co., Ltd., Suwon-si (KR)

(72) Inventors: Jing Li, Plano, TX (US); Pavan C. Madhusudanarao, Redmond, WA (US); Chengyu Wang, Plano, TX (US); Hamid Rahim Sheikh, Allen, TX (US); John Seokjun Lee, Allen, TX (US)

(21) Appl. No.: 19/253,569

(22) Filed: Jun. 27, 2025

Related U.S. Application Data
(60) Provisional application No. 63/774,553, filed on Mar. 19, 2025.

(51) Int. Cl. H04N 7/01; H04N 19/124; H04N 19/172; H04N 19/196; H04N 19/44; H04N 19/553

(52) U.S. Cl. CPC H04N 7/0127; H04N 7/014; H04N 19/124; H04N 19/172; H04N 19/196; H04N 19/44; H04N 19/553

(57) ABSTRACT

A method includes obtaining, using at least one processing device of an electronic device, input video frames in a pixel space. The method also includes compressing, using the at least one processing device, two adjacent input video frames to obtain corresponding input latent feature sets in a latent space. The method further includes generating, using the at least one processing device, intermediate latent feature sets in the latent space based on the input latent feature sets. The method also includes decompressing, using the at least one processing device, the intermediate latent feature sets to obtain interpolated video frames in the pixel space. In addition, the method includes inserting, using the at least one processing device, the interpolated video frames between the two adjacent input video frames to obtain a slow motion video.

### CROSS-REFERENCE TO RELATED APPLICATION AND PRIORITY CLAIM

This application claims priority under 35 U.S.C. § 119 (e) to U.S. Provisional Patent Application No. 63/774,553 filed on Mar. 19, 2025, which is hereby incorporated by reference in its entirety.

### TECHNICAL FIELD

This disclosure relates generally to video processing systems. More specifically, this disclosure relates to compressed-domain high-resolution slow motion video processing.

### BACKGROUND

Slow motion video has been a key enabler for mobile devices. However, current slow motion video processing systems suffer from various drawbacks, such as lower resolutions, loss of details, and inaccurate motion model-induced artifacts. While mobile devices now include higher-resolution cameras, higher-resolution slow motion video processing is challenging due to the computational demands and memory consumption associated with higher-resolution images.

### SUMMARY

This disclosure relates to compressed-domain high-resolution slow motion video processing.

In a first embodiment, a method includes obtaining, using at least one processing device of an electronic device, input video frames in a pixel space. The method also includes compressing, using the at least one processing device, two adjacent input video frames to obtain corresponding input latent feature sets in a latent space. The method further includes generating, using the at least one processing device, intermediate latent feature sets in the latent space based on the input latent feature sets. The method also includes decompressing, using the at least one processing device, the intermediate latent feature sets to obtain interpolated video frames in the pixel space. In addition, the method includes inserting, using the at least one processing device, the interpolated video frames between the two adjacent input video frames to obtain a slow motion video.

In a second embodiment, an electronic device includes at least one processing device configured to obtain input video frames in a pixel space and compress two adjacent input video frames to obtain corresponding input latent feature sets in a latent space. The at least one processing device is also configured to generate intermediate latent feature sets in the latent space based on the input latent feature sets and decompress the intermediate latent feature sets to obtain interpolated video frames in the pixel space. In addition, the at least one processing device is configured to insert the interpolated video frames between the two adjacent input video frames to obtain a slow motion video.

Any single one or any combination of the following features may be used with the first or second embodiment.

The input latent feature sets may include continuous input latent feature sets, and the latent space may include a continuous latent space. The two adjacent input video frames may be compressed by (i) encoding, using a machine learning model, the two adjacent input video frames to obtain corresponding continuous vector representations in the continuous latent space; (ii) performing, using the machine learning model, vector quantization on the continuous vector representations to obtain corresponding discrete latent feature sets in a discrete latent space; and (iii) performing, using the machine learning model, vector de-quantization on the discrete latent feature sets to obtain corresponding continuous input latent feature sets in the continuous latent space.

The vector quantization may be performed by performing hierarchical vector quantization on the continuous vector representations to obtain, for each of the continuous vector representations, a first-level discrete latent feature set and a second-level discrete latent feature set that is conditioned on the first-level discrete latent feature set.

The vector de-quantization may be performed by performing hierarchical vector de-quantization on each first- and second-level discrete latent feature set to obtain the corresponding continuous input latent feature set.

The intermediate latent feature sets may include intermediate continuous latent feature sets, and the intermediate continuous latent feature sets may be decompressed by decoding, using the machine learning model, the intermediate continuous latent feature sets to obtain corresponding interpolated video frames in the pixel space.

The intermediate latent feature sets may be generated by (i) estimating, using a first machine learning model, intermediate optical flows in the latent space based on the input latent feature sets; (ii) estimating, using a second machine learning model, an occlusion mask in the latent space based on the intermediate optical flows; and (iii) performing, using a third machine learning model, frame interpolation in the latent space based on the input latent feature sets, the intermediate optical flows, and the occlusion mask to generate the intermediate latent feature sets.

The intermediate optical flows may include forward and backward intermediate optical flows, and the intermediate optical flows may be estimated by (i) estimating, using the first machine learning model, forward and backward input optical flows for the two adjacent input video frames based on the input latent feature sets in the latent space; and (ii) performing bilinear interpolation on the estimated forward and backward input optical flows in the latent space to estimate the forward and backward intermediate optical flows.

The intermediate optical flows may include forward and backward intermediate optical flows, and the occlusion mask may be estimated by estimating the occlusion mask from the estimated forward and backward intermediate optical flows in the latent space.

The intermediate optical flows may include forward and backward intermediate optical flows, and the frame interpolation may be performed by (i) warping the input latent feature set corresponding to an earlier of the two adjacent input video frames with the estimated forward intermediate optical flow to obtain a forward intermediate feature set; (ii) warping the input latent feature set corresponding to a later of the two adjacent input video frames with the estimated backward intermediate optical flow to obtain a backward intermediate feature set; (iii) applying the occlusion mask to the forward and backward intermediate feature sets; and (iv) applying the third machine learning model to the forward and backward intermediate feature sets to generate the intermediate latent feature sets.

The forward and backward intermediate feature sets may be concatenated after application of the occlusion mask to generate a concatenation result, and the third machine learning model may be applied to the forward and backward intermediate feature sets to generate the intermediate latent feature sets by applying a Nonlinear Activation Free Network (NAFNet) to the concatenation result to generate the intermediate latent feature sets.

A non-transitory machine-readable medium may contain instructions that when executed cause at least one processor of an electric device to perform the method of the first embodiment, optionally with any one or any combination of the features described above.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example compressed-domain high-resolution slow motion video processing system in accordance with this disclosure;

FIGS. 3A-3C illustrate example interpolated frames of a 4K slow motion video;

FIG. 4 illustrates an example image signal processing (ISP) pipeline for 4K slow motion video generation in accordance with this disclosure;

FIG. 5 illustrates an example improved ISP pipeline for high-resolution slow motion video generation in accordance with this disclosure;

FIG. 6 illustrates an example system for efficiently generating high-resolution slow motion video in accordance with this disclosure;

FIG. 7 illustrates an example compression system in accordance with this disclosure;

FIG. 8 illustrates an example compressed-domain optical flow estimation system in accordance with this disclosure;

FIG. 9 illustrates an example compressed-domain occlusion mask estimation system in accordance with this disclosure;

FIG. 10 illustrates an example compressed-domain frame interpolation system in accordance with this disclosure;

FIG. 11 illustrates an example comparison between a pixel-domain optical flow calculation and a compressed-domain optical flow calculation in accordance with this disclosure;

FIGS. 12A-12B illustrate an example comparison of resolution between an interpolated 4K frame and an interpolated 8K frame in accordance with this disclosure;

FIGS. 13A-13B illustrate an example comparison of image details between an interpolated 4K frame and an interpolated 8K frame in accordance with this disclosure;

FIGS. 14A-14B illustrate an example comparison of motion artifacts between an interpolated 4K frame and an interpolated 8K frame in accordance with this disclosure; and

FIG. 15 illustrates an example method for compressed-domain high-resolution slow motion video processing in accordance with this disclosure.

### DETAILED DESCRIPTION

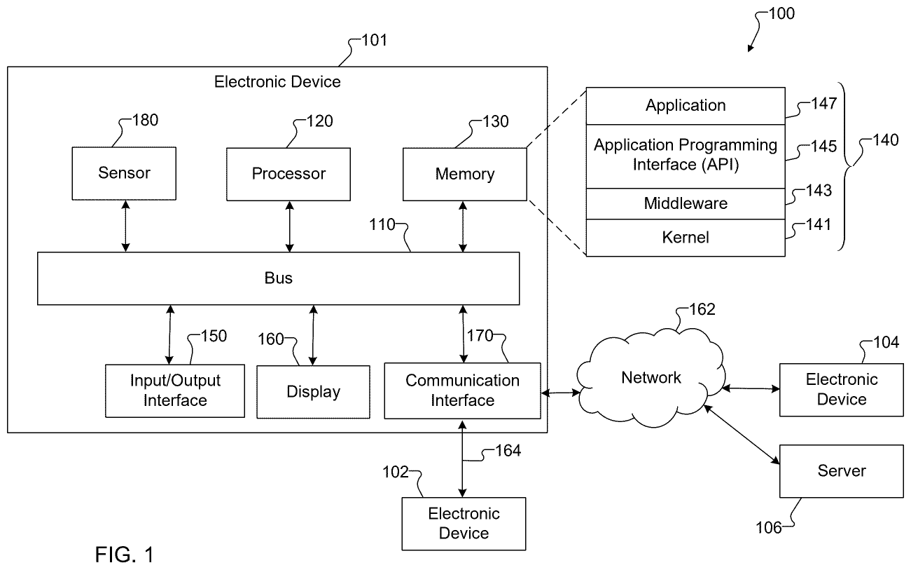

FIGS. 1 through 15, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, slow motion video has been a key enabler for mobile devices. However, current slow motion video processing systems suffer from various drawbacks, such as lower resolutions, loss of details, and inaccurate motion model-induced artifacts. While mobile devices now include higher-resolution cameras, higher-resolution slow motion video processing is challenging due to the computational demands and memory consumption associated with higher-resolution images.

This disclosure provides various techniques for compressed-domain high-resolution slow motion video processing. As described in more detail below, ultra-high definition (UHD) or other input video frames in a pixel space can be obtained, and two adjacent input video frames can be compressed to obtain corresponding input latent feature sets in a latent space. Intermediate latent feature sets can be generated in the latent space based on the input latent feature sets, and the intermediate latent feature sets can be decompressed to obtain interpolated video frames in the pixel space. The interpolated video frames can be inserted between the two adjacent input video frames to obtain a slow motion video.

In this way, embodiments of this disclosure enable mapping input video frames into a compressed domain, generating compressed-domain representations of interpolated frames based on the compressed-domain representations of the input video frames, and regenerating interpolated frames in the pixel domain from the corresponding compressed-domain representations. In some cases, artificial intelligence (AI)/machine learning (ML) models that are trained to operate on compressed-domain representations (such as latent feature sets) of video frames may be used. Overall, these approaches can provide improved video generation and improved image quality (IQ) using efficient and effective compressed-domain slow motion video processing.

Note that while various embodiments of this disclosure are described below as being used to generate slow motion video having an 8K resolution, it will be understood that this is only one example, and the embodiments of this disclosure may be used with any suitable resolution(s) of video content. Also, while some embodiments discussed below are described in the context of use in consumer electronic devices (such as smartphones), this is merely one example. It will be understood that the principles of this disclosure may be implemented in any number of other suitable contexts and may use any suitable device or devices. Further, note that while some embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to compressed-domain high-resolution slow motion video processing.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform compressed-domain high-resolution slow motion video processing. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to compressed-domain high-resolution slow motion video processing.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

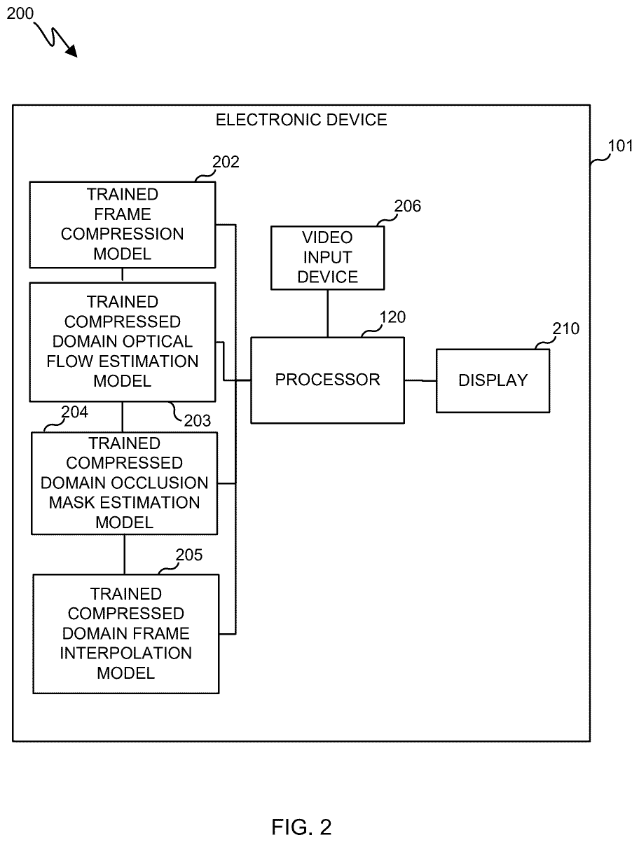

FIG. 2 illustrates an example compressed-domain high-resolution slow motion video processing system 200 in accordance with this disclosure. For ease of explanation, the system 200 is described as being implemented using the electronic device 101 in the network configuration 100 of FIG. 1. However, the system 200 may be used with any other suitable device(s), such as the server 106, and in any other suitable system(s).

As shown in FIG. 2, the system 200 includes the processor 120, which is operatively coupled to or otherwise configured to use one or more machine learning models, such as a frame compression model 202, a compressed-domain optical flow estimation model 203, a compressed-domain occlusion mask estimation model 204, and a compressed-domain frame interpolation model 205. Each of these models 202-205 represents any suitable AI/ML model that can be trained to perform the functions described below. Each of these models 202-205 can also have any suitable AI/ML architecture.

The frame compression model 202 represents a model that can be trained to map pixel data of higher-resolution image frames into a compressed domain or latent space, generating a compressed-domain representation or latent feature set for each frame. In some embodiments, the frame compression model 202 can represent a hierarchical vector-quantized variational autoencoder (VQ-VAE).

The compressed-domain optical flow estimation model 203 represents a model that can be trained to estimate bi-directional optical flows for interpolated frames in the compressed domain. The compressed-domain occlusion mask estimation model 204 represents a model that can be trained to estimate occlusion masks in the compressed-domain based on the estimated bi-directional optical flows for the interpolated frames. The compressed-domain frame interpolation model 205 represents a model that can be trained to generate latent feature sets (referred to as intermediate latent feature sets) representing the interpolated frames based on the estimated bi-directional optical flows and the estimated occlusion masks. The frame compression model 202 can additionally be trained to map the intermediate latent feature sets back into the pixel space of the original input frames to create interpolated high-resolution frames. In some embodiments, these models 202-205 can be trained in an end-to-end manner at the same time, meaning the parameters of all models 202-205 can be adjusted during the training.

In some embodiments, the models 202-205 can be stored in a memory of the electronic device 101 (such as the memory 130) and accessed by the processor 120 of the electronic device 101 to perform high-resolution slow motion video generation or other tasks. In other embodiments, one or more of the models 202-205 can be stored in any other suitable manner, such as when one or more of the models 202-205 are stored remotely from the electronic device 101 (such as in the server 106). In these embodiments, the electronic device 101 can transmit requests including inputs (such as captured video frame data or other data) to the server 106 for processing of the inputs using one or more machine learning models, and the results can be sent back to the electronic device 101.

The system 200 also includes a video input device 206 (such as one or more cameras or other imaging sensors 180) and a display 210 (such as a screen or monitor like the display 160). Here, the processor 120 can receive high-resolution video frames from the video input device 206 and provide the video frames to the trained frame compression model 202. The trained frame compression model 202 can map input frame pixel data for a pair of video frames into a latent space and output a latent feature set to the processor 120. The processor 120 can provide the latent feature set to the trained compressed-domain optical flow estimation model 203, which can generate estimated intermediate bi-directional optical flows in the latent space. The intermediate bi-directional optical flows correspond to a frame that the system 200 is interpolating between the pair of video frames.

The processor 120 can provide the estimated intermediate bi-directional optical flows to the trained compressed-domain occlusion mask estimation model 204, which can generate an estimated occlusion mask in the latent space. The estimated occlusion mask also corresponds to the interpolated frame. The processor 120 can provide the estimated intermediate bi-directional optical flows and the estimated occlusion mask to the trained compressed-domain frame interpolation model 205, which can generate an intermediate latent feature set based on the estimated intermediate bi-directional optical flows and the estimated occlusion mask. The intermediate latent feature set represents the interpolated frame in the latent space.

The processor 120 can provide the intermediate latent feature set to the trained frame compression model 202, which can regenerate a high-resolution interpolated frame in the pixel domain from the intermediate latent feature set. The processor 120 can insert the interpolated frame between the pair of video frames. Note that this process can be repeated any desired number of times to generate additional high-resolution interpolated frames to assemble a high-resolution slow motion video. For example, three interpolated frames may be inserted between each pair of video frames, resulting in a “4×” slow motion video (meaning the slow motion video when played has one-fourth the speed of the original video).

Although FIG. 2 illustrates one example of a compressed-domain high-resolution slow motion video processing system 200, various changes may be made to FIG. 2. For example, various components, operations, or functions in FIG. 2 may be combined, further subdivided, replicated, omitted, or rearranged and additional components, operations, or functions may be added according to particular needs. Also, depending on the implementation, the models 202-205 may be stored as separate models called upon by the processor 120 to perform certain tasks or may be included in or form at least a part of one or more larger machine learning models.

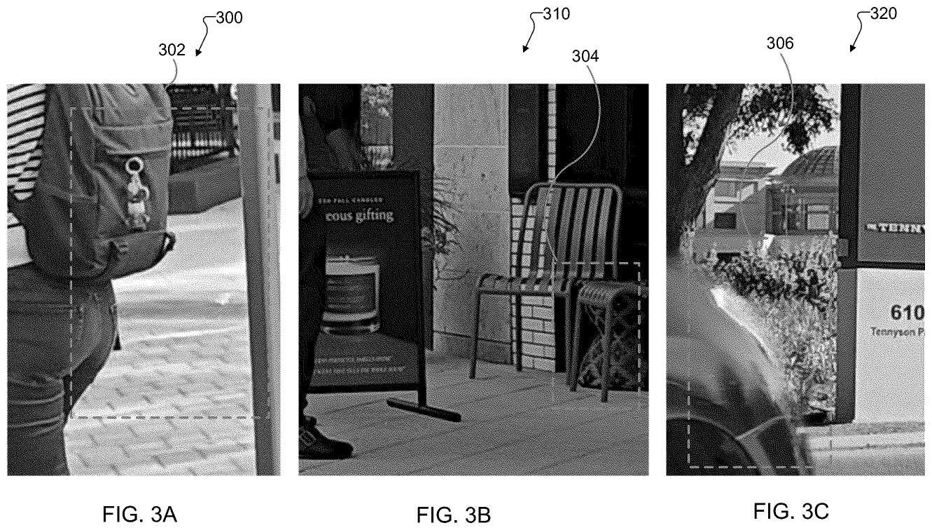

FIGS. 3A-3C illustrate example interpolated frames 300, 310, 320 of a 4K slow motion video. In particular, the interpolated frames 300, 310, 320 here represent frames of a 4K slow motion video, and the interpolated frames 300, 310, 320 illustrate various deficiencies of 4K slow motion video generation techniques. For example, the interpolated frame 300 of FIG. 3A has relatively low resolution, visible in a highlighted area 302 among other places. The interpolated frame 310 of FIG. 3B has a loss of detail, visible in objects within a highlighted area 304 among other places. The interpolated frame 320 of FIG. 3C has motion artifacts, visible in objects within a highlighted area 306 among other places.

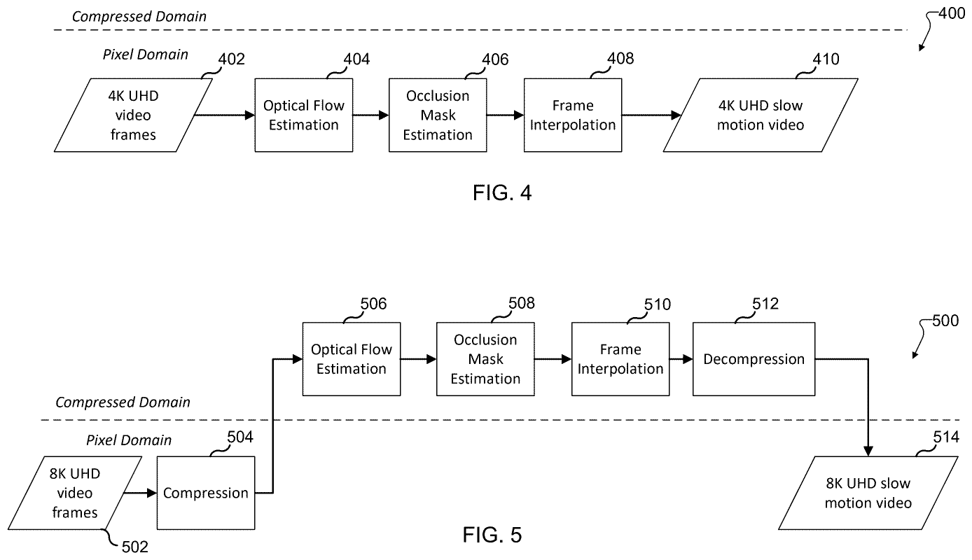

FIG. 4 illustrates an example image signal processing (ISP) pipeline 400 for 4K slow motion video generation. In a typical mobile device, 4K image frames have a resolution of 3840×2160 pixels, which totals around 8.3 million pixels. As shown in FIG. 4, all processing occurs in the pixel domain. That is, the ISP pipeline 400 takes pixel data for each pixel of the 4K resolution input video frames 402 and performs optical flow estimation 404, occlusion mask estimation 406, and frame interpolation 408 using the full 4K resolution input pixel data to generate 4K resolution-interpolated frames for a 4K slow motion video 410. The pixel data for each pixel typically includes values for multiple color channels (such as three or more color channels) for each pixel. Accordingly, significant memory and processing power are needed to generate interpolated frames in the pixel domain at such high resolutions.

Embodiments of this disclosure efficiently generate high-resolution (such as 8K) slow motion video in the compressed domain. These embodiments reduce the computational load and memory requirements of an ISP pipeline. In a typical mobile device, 8K image frames have a resolution of 7680×4320 pixels, which totals over 33 million pixels. Even so, using the embodiments described below, devices that were limited by computational and memory resources to 4K slow motion video generation are able to generate 8K slow motion video or other higher-resolution slow motion video.

FIG. 5 illustrates an example improved ISP pipeline 500 for high-resolution (such as 8K) slow motion video generation in accordance with this disclosure. For ease of explanation, the ISP pipeline 500 is described as being implemented using the electronic device 101 in the network configuration 100 of FIG. 1. However, the ISP pipeline 500 may be used with any other suitable device(s), such as the server 106, and in any other suitable system(s).

As shown in FIG. 5, part of the processing occurs in the ISP pipeline 500 occurs in the compressed domain. In this example, the ISP pipeline 500 obtains pixel data of input video frames 502, compresses the pixel data, and processes the compressed data to generate 8K resolution-interpolated frames for an 8K slow motion video 514. In some embodiments,

AI/ML models are used in the ISP pipeline 500. For example, an AI/ML-based compression model (such as the model 202) may perform compression 504 of the video frames 502 into the compressed-domain (such as a latent space). An AI/ML-based optical flow estimation model (such as the model 203) may be used for optical flow estimation 506 in the latent space. An AI/ML-based occlusion mask estimation model (such as the model 204) may be used for occlusion mask estimation 508 in the latent space. An AI/ML-based frame interpolation model (such as the model 205) may be used for frame interpolation 510 in the latent space. An AI/ML-based decompression model (such as the model 202) may perform decompression 512 to regenerate 8K resolution-interpolated frames in the pixel domain. The various operations 506-512 here are performed in the compressed domain and therefore can involve significantly lower computational and memory resources than the corresponding pixel-domain operations of FIG. 4.

The ISP pipeline 500 here can therefore be generally described with respect to two elements, namely (i) a compression technique for compressing higher-resolution (such as 8K) pixel-domain video frames into a compressed domain and (ii) conversion and interpolation operations in the compressed domain. In some embodiments, the compression technique may target a “4×” compression ratio and can map pixel data of the input video frames from the pixel domain to a latent space, resulting in latent space representations (such as latent feature sets) of the video frames having roughly one-fourth the size of the video frames. The conversion and interpolation operations operate on the latent space representations to perform optical flow estimation, occlusion mask estimation, and frame interpolation, thereby generating latent space representations (such as latent feature sets) corresponding to interpolated frames. The latent feature sets corresponding to interpolated frames may be referred to as intermediate latent feature sets. A corresponding decompression technique can regenerate the interpolated video frames in the pixel domain from the corresponding intermediate latent feature sets. The interpolated pixel-domain frames can be inserted between the input pixel-domain frames to increase the effective frame rate of the video, thereby generating a slow motion video.

Although FIG. 5 illustrates one example of an improved ISP pipeline 500 for high-resolution slow motion video generation, various changes may be made to FIG. 5. For example, various components, operations, or functions in FIG. 5 may be combined, further subdivided, replicated, omitted, or rearranged and additional components, operations, or functions may be added according to particular needs. Also, resolutions other than 4K and 8K may be used here.

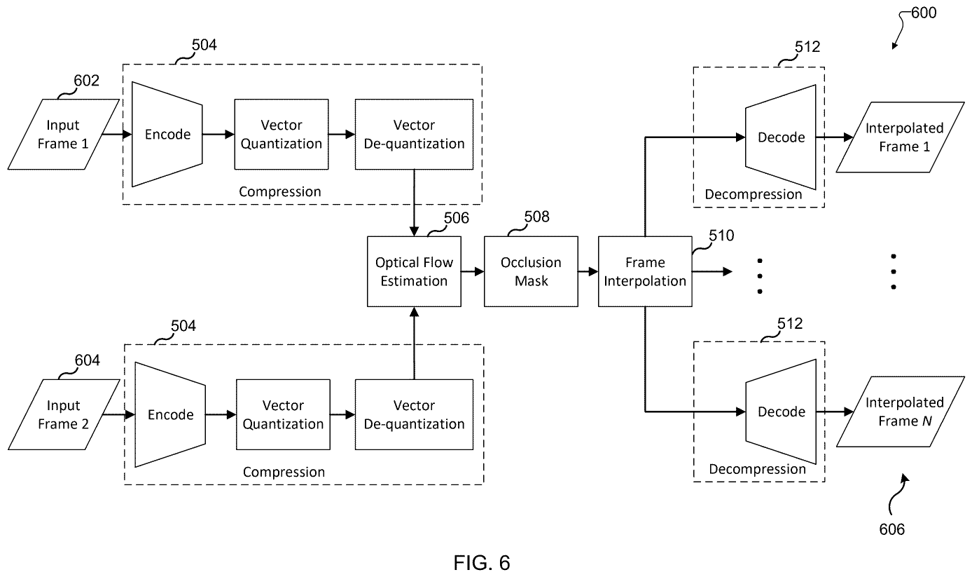

FIG. 6 illustrates an example system 600 for efficiently generating high-resolution (such as 8K) slow motion video in accordance with this disclosure. For ease of explanation, the system 600 is described as being implemented using the electronic device 101 in the network configuration 100 of FIG. 1. However, the system 600 may be used with any other suitable device(s), such as the server 106, and in any other suitable system(s).

As shown in FIG. 6, the system 600 processes two pixel-domain input video frames 602 and 604 (such as 8K video frames) as inputs. Each input frame 602 and 604 undergoes compression 504 to obtain corresponding latent feature sets in a latent space (such as input latent feature sets). In this particular example, the compression 504 includes encoding, vector quantization, and vector de-quantization operations. Optical flow estimation 506, occlusion mask estimation 508, and frame interpolation 510 are performed in the latent space using the input latent features sets to generate intermediate latent feature sets corresponding to interpolated frames. After this, decompression 512 is performed to regenerate interpolated frames 606 in the pixel domain from the intermediate feature sets. In this particular example, decompression 512 includes a decoding operation, which corresponds to but reverses the encoding operation of the compression 504.

Any number N of interpolated frames 606 may be generated in this way. In order to achieve a “4×” slow motion, for example, N=3, meaning three interpolated frames 606 are generated. This can be repeated for any number of pairs of video frames 602 and 604 in order to produce a slow motion video sequence.

Although FIG. 6 illustrates one example of a system 600 for efficiently generating high-resolution slow motion video, various changes may be made to FIG. 6. For example, various components, operations, or functions in FIG. 6 may be combined, further subdivided, replicated, omitted, or rearranged and additional components, operations, or functions may be added according to particular needs. Also, resolutions other than 4K and 8K may be used here.

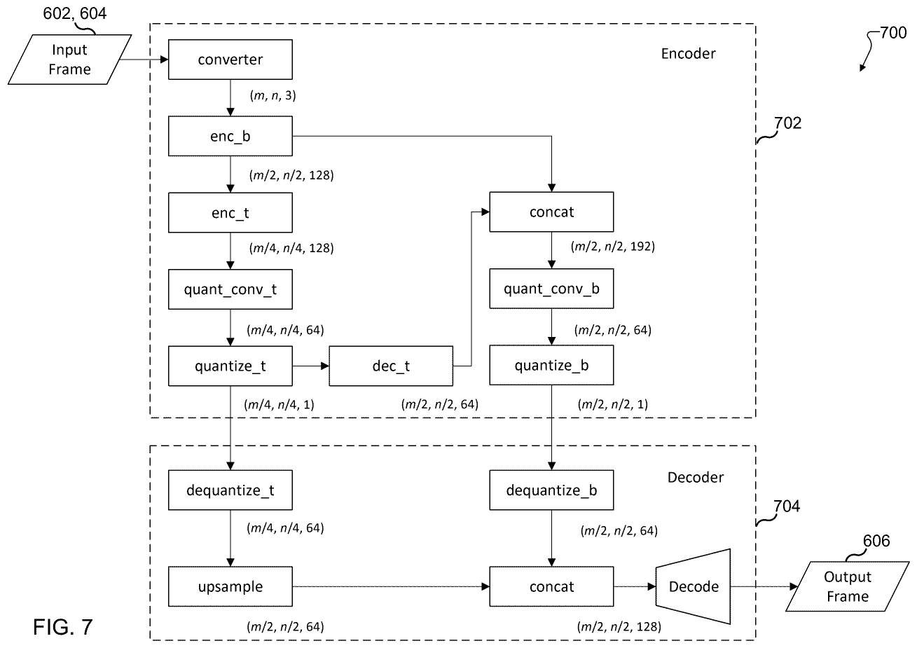

FIG. 7 illustrates an example compression system 700 in accordance with this disclosure. The compression system 700 may, for example, be used to implement the compression 504 and decompression 512 of FIGS. 5 and 6. In this example, the compression system 700 uses a hierarchical vector-quantized variational autoencoder (VQ-VAE) AI/ML model that has been trained with semi-supervised learning. More specifically, the hierarchical VQ-VAE in this example uses downsample factors of four and two to preserve image details (compared to, for example, a VQ-VAE 2 model that uses downsample factors of eight and four).

As shown in FIG. 7, the compression system 700 operates on an input frame 602 or 604 having m×n pixels and three color channels (such as YUV, RGB, or the like). Accordingly, the input frame 602 or 604 has a dimensionality of (m, n, 3). An encoder portion 702 of the system 700 (corresponding to part of the compression 504) encodes and vector-quantizes the input frame's pixel data to map the pixel data into hierarchical discrete latent feature sets (such as top-level and bottom-level discrete latent feature sets) in a discrete latent space. More specifically, the encoding maps the pixel data from the pixel space to a continuous latent space, generating top- and bottom-level continuous latent feature sets. The vector quantization maps those hierarchical continuous latent feature sets to the discrete latent space. In this example, the resulting top- and bottom-level discrete latent feature sets represent the input frame 602 or 604 in the discrete latent space with reduced dimensionality of (m/4, n/4, 1) and (m/2, n/2, 1), respectively.

A decoder portion 704 of the system 700 (corresponding to part of the compression 504 and the decompression 512) de-quantizes and decodes hierarchical discrete latent feature sets generated by the encoder portion 702. In this example, the decoder portion 704 operates on top- and bottom-level hierarchical discrete latent feature sets having dimensionality of (m/4, n/4, 1) and (m/2, n/2, 1), respectively, to produce an interpolated frame 606 in the pixel domain with a dimensionality of (m, n, 3). That is, the decoder portion 704 produces an interpolated frame 606 having the same resolution in the same color space as the input frame 602 or 604. In some embodiments, for an eight-bit YUV image, the baseline compression ratio (r) of the compression system 700 may be 4.27, which can be determined as shown below.

$$r = \frac{m * n * 1.5 * 8}{\frac{m}{4} * \frac{n}{4} * 9 + \frac{m}{2} * \frac{n}{2} * 9} = 4.27 \qquad ( 1 )$$

Although FIG. 7 illustrates one example of a compression system 700, various changes may be made to FIG. 7. For example, various components, operations, or functions in FIG. 7 may be combined, further subdivided, replicated, omitted, or rearranged and additional components, operations, or functions may be added according to particular needs. Also, the compression system 700 is not limited to a VQ-VAE model architecture and may use any other suitable approach for vector quantization on top of a different encoder-decoder model architecture, such as channel attention models (like a nonlinear activation free network (NAFNet) or a transformer based Restormer network).

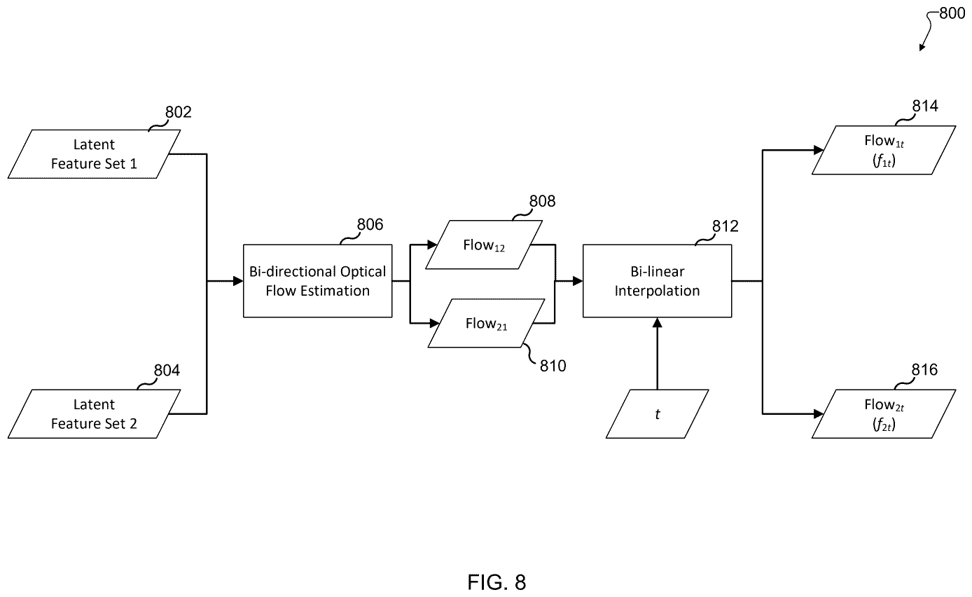

FIG. 8 illustrates an example compressed-domain optical flow estimation system 800 in accordance with this disclosure. The compressed-domain optical flow estimation system 800 may, for example, be used to implement the optical flow estimation 506 of FIGS. 5 and 6. As shown in FIG. 8, the system 800 takes as input two latent feature sets 802 and 804, which could correspond to the two input frames 602 and 604. The system 800 uses the latent feature sets 802 and 804 to estimate intermediate optical flows between an interpolated frame and each of the input frames 602 and 604. By operating on compact latent feature sets in the compressed-domain rather than full pixel data of the original input frames, the system 800 saves significant computation and memory resources.

The system 800 performs bi-directional optical flow estimation 806 on the latent feature sets 802 and 804, generating a forward optical flow 808 (Flow₁₂) and a backward optical flow 810 (Flow₂₁). These flows represent the optical flows in each direction between the two input frames 602 and 604. In this example, the bi-directional optical flow estimation 806 uses an optical flow estimation model based on a modified recurrent all-pairs field transforms (RAFT) model, which can be trained using latent feature sets. However, the RAFT model is modified to add one convolutional layer to feed in latent feature sets and uses the latent feature set 802 (corresponding to the first input frame 602) as a context input.

Once the bi-directional optical flows 808 and 810 for the input frames are obtained, a forward intermediate optical flow 814 (Flow₁ₜ or f₁ₜ) and a backward intermediate optical flow 816 (Flow₂ₜ or f₂ₜ) for an interpolated frame are estimated, such as by using bi-linear interpolation 812. In some embodiments, the bi-linear interpolation 812 may operate as follows. Given t∈(0,1), coefficients for the bi-linear interpolation may be computed as follows.

$$f C o e f = [ - t * ( 1 - t ) , t * t , ( 1 - t ) * ( 1 - t ) , - t * ( 1 - t ) ] \qquad ( 2 )$$

Using these coefficients, the estimated intermediate optical flows 814 and 816 may be generated from the bi-directional optical flows 808 and 810, such as in the following manner.

$${f}_{1 t} = f C o e f [ 0 ] * {Flow}_{12} + f C o e f [ 1 ] * {Flow}_{21} \qquad ( 3 )$$

$${f}_{2 t} = f C o e f [ 2 ] * {Flow}_{12} + f C o e f [ 3 ] * {Flow}_{21} \qquad ( 4 )$$

Although FIG. 8 illustrates one example of a compressed-domain optical flow estimation system 800, various changes may be made to FIG. 8. For example, various components, operations, or functions in FIG. 8 may be combined, further subdivided, replicated, omitted, or rearranged and additional components, operations, or functions may be added according to particular needs. Also, the system 800 is not limited to a RAFT model architecture or bi-linear interpolation, and other optical flow estimation techniques (such as block matching-based techniques or other techniques using architectures such as FlowNet or GMFlow) and other interpolation techniques may be used.

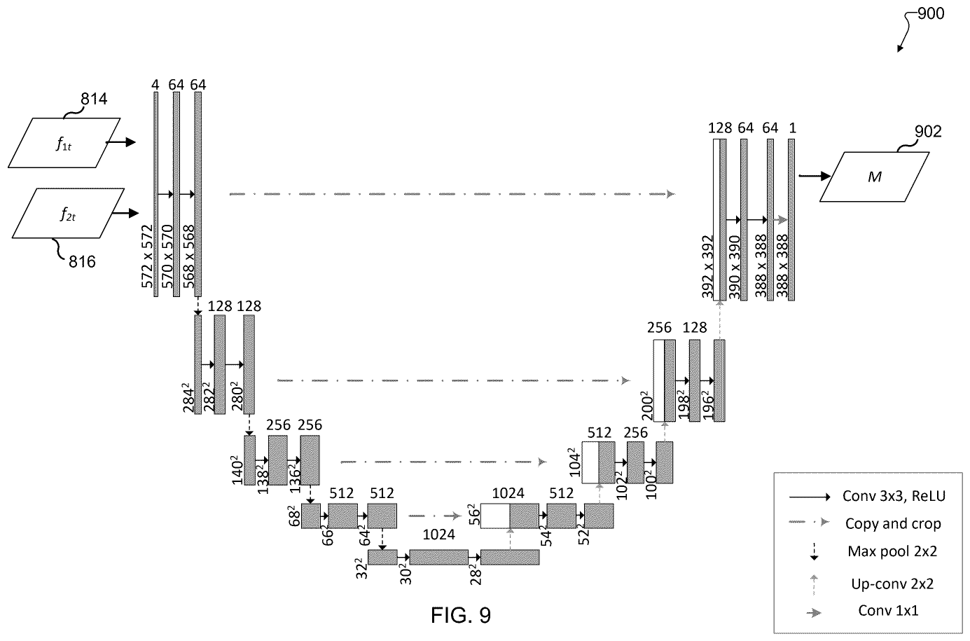

FIG. 9 illustrates an example compressed-domain occlusion mask estimation system 900 in accordance with this disclosure. The compressed-domain occlusion mask estimation system 900 may, for example, be used to implement the occlusion mask estimation 508 of FIGS. 5 and 6. As shown in FIG. 9, the system 900 takes as input the estimated bi-directional intermediate optical flows 814 (Flow₁ₜ or f₁ₜ) and 816 (Flow₂ₜ or f₂ₜ), which may be generated by the compressed-domain optical flow estimation system 800 of FIG. 8. The system 900 uses the intermediate optical flows 814 and 816 to estimate an occlusion mask 902 (M). By operating in the compressed domain, the system 900 saves significant computation and memory resources.

In this example, the compressed-domain occlusion mask estimation system 900 uses a U-net architecture that takes the intermediate optical flows 814 and 816 as inputs, which the U-net architecture treats as a four-channel feature map. The system 900 outputs an estimated occlusion mask 902 (M). For the purposes of the U-net architecture, this output may be treated as a one-channel segmentation map. In some embodiments, the U-net architecture of the system 900 can be incorporated into an overall system architecture (such as the ISP pipeline 500 or system 600) for training. That is, the U-net architecture need not be trained as a standalone model but can be trained as part of an end-to-end training process incorporating all parts of the system. When trained in this manner, there may be little or no need for ground truth occlusion mask data.

Although FIG. 9 illustrates one example of a compressed-domain occlusion mask estimation system 900, various changes may be made to FIG. 9. For example, various components, operations, or functions in FIG. 9 may be combined, further subdivided, replicated, omitted, or rearranged and additional components, operations, or functions may be added according to particular needs. Also, the system 900 is not limited to a U-net model architecture, and other occlusion mask estimation techniques may be used.

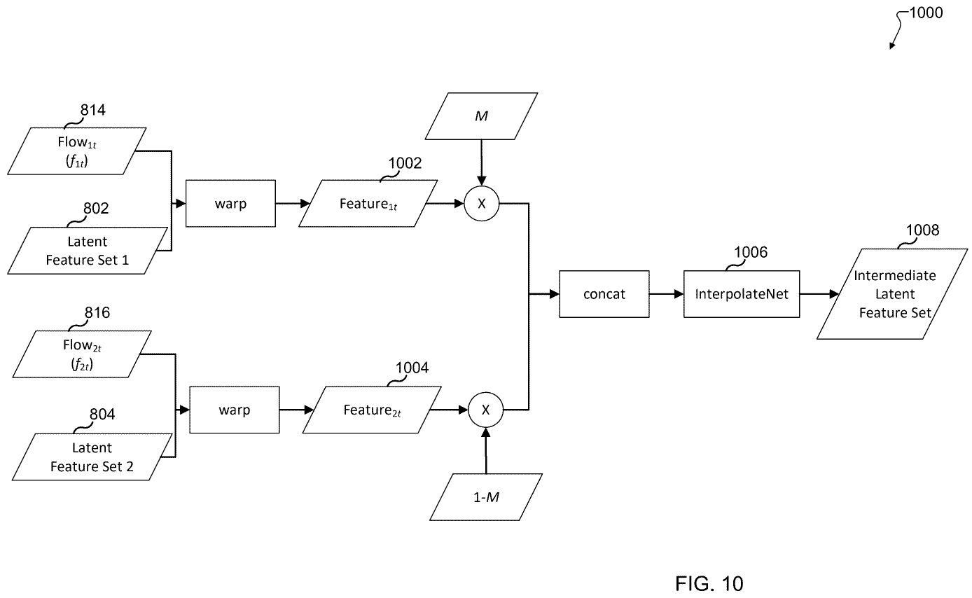

FIG. 10 illustrates an example compressed-domain frame interpolation system 1000 in accordance with this disclosure. The compressed-domain frame interpolation system 1000 may, for example, be used to implement the frame interpolation 510 of FIGS. 5 and 6. As shown in FIG. 10, the compressed-domain frame interpolation system 1000 receives the input latent feature sets 802 and 804 and the estimated intermediate optical flows 814 and 816 as inputs. The system 1000 warps the latent feature set 802 (corresponding to the first input frame 602) with the estimated forward intermediate optical flow 814 (f₁ₜ) to generate a forward-warped intermediate latent feature set 1002 (Feature₁ₜ). Similarly, the system 1000 warps the latent feature set 804 (corresponding to the second input frame 604) with the estimated backward intermediate optical flow 816 (f₂ₜ) to generate a backward-warped intermediate latent feature set 1004 (Feature₂ₜ).

The system 1000 concatenates the bi-directional warped intermediate latent feature sets 1002 and 1004 using occlusion, such as applying the estimated occlusion mask 902 (M). The system also applies an AI/ML model 1006 to generate a final intermediate latent feature set 1008, which is a compressed-domain representation of an interpolated frame. In this example, the AI/ML model 1006 is referred to as “InterpolateNet,” which represents a NAFNet architecture with a modified input/output channel number. A pixel domain-interpolated frame (such as an interpolated frame 606 of FIG. 6) may be regenerated from the final intermediate latent feature set 1008 as discussed above with respect to the decompression 512 of FIGS. 5 and 6 and the decoder portion 704 of the compression system 700 of FIG. 7.

Although FIG. 10 illustrates one example of a compressed-domain frame interpolation system 1000, various changes may be made to FIG. 10. For example, various components, operations, or functions in FIG. 10 may be combined, further subdivided, replicated, omitted, or rearranged and additional components, operations, or functions may be added according to particular needs. Also, the system 1000 is not limited to an InterpolateNet or NAFNet architecture, and other frame interpolation techniques may be used.

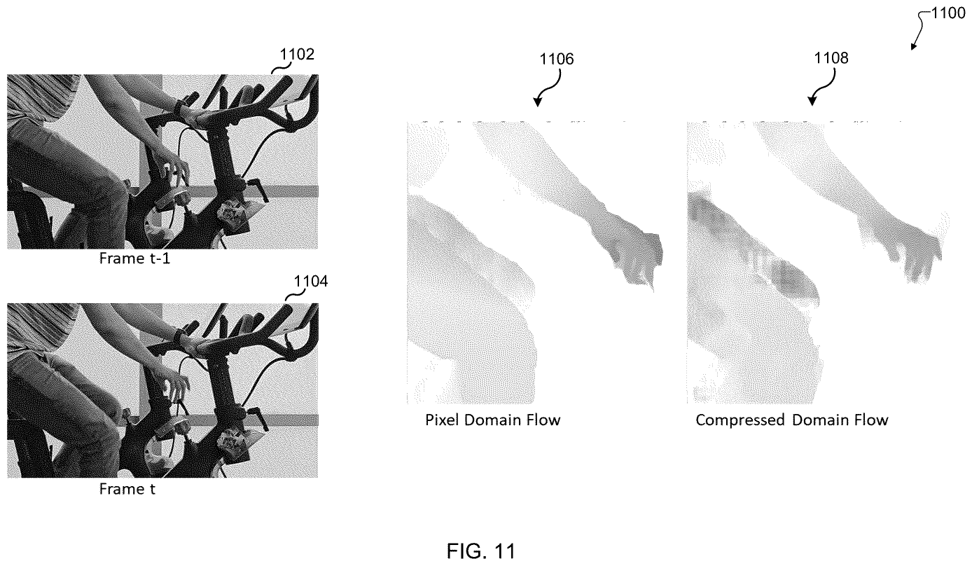

FIG. 11 illustrates an example comparison 1100 between a pixel-domain optical flow calculation and a compressed-domain optical flow calculation in accordance with this disclosure. In this example, FIG. 11 illustrates a first video frame 1102 and a second video frame 1104. An optical flow image 1106 reflects an estimation of an optical flow between the first frame 1102 and the second frame 1104 calculated in the pixel domain. An optical flow image 1108 reflects an estimation of this optical flow calculated in the compressed-domain according to the embodiments of this disclosure above. As shown in FIG. 11, the compressed-domain optical flow estimation result is acceptably similar to the pixel-domain optical flow estimation result. At the same time, the compressed-domain optical flow estimation uses significantly fewer resources (such as roughly one-fourth of the memory) of the pixel-domain estimation and takes less computation time (such as roughly half) to complete.

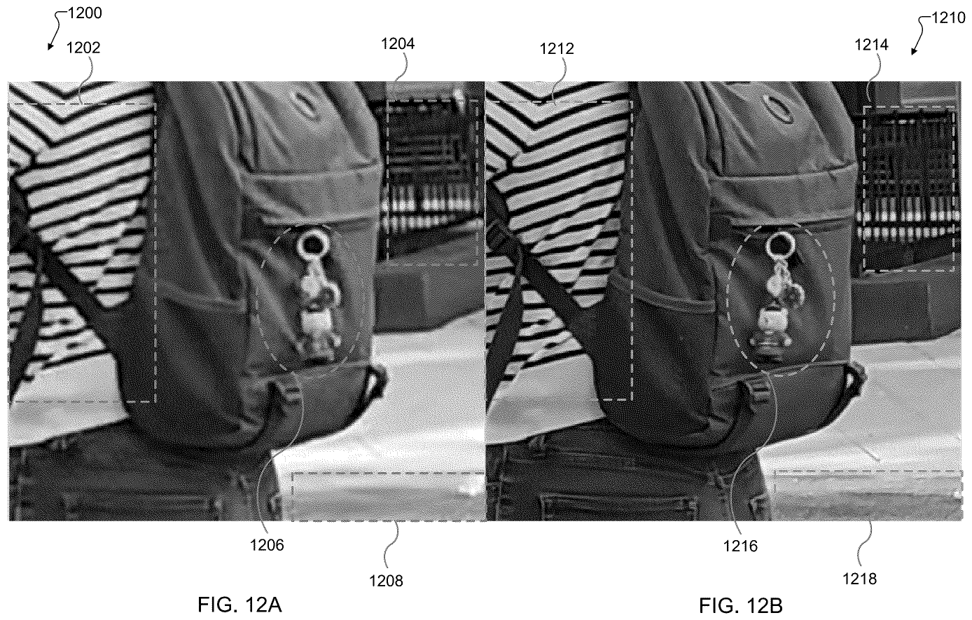

FIGS. 12A-12B illustrate an example comparison of resolution between an interpolated 4K frame 1200 and an interpolated 8K frame 1210 in accordance with this disclosure. In this example, the interpolated frames 1200 and 1210 are generated from video of the same scene, and similar areas of each frame are highlighted for comparison. Specifically, each area 1202-1208 of the frame 1200 may be compared, respectively, to each area 1212-1218 of the frame 1210. As can be seen here, there is notable improvement in resolution in the 8K frame 1210 as compared to the 4K frame 1200.

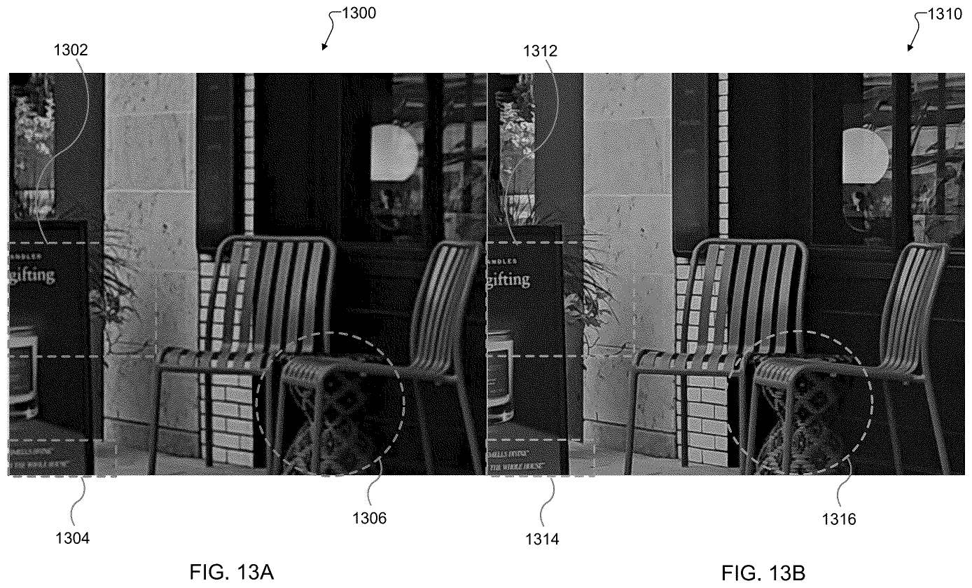

FIGS. 13A-13B illustrate an example comparison of image details between an interpolated 4K frame 1300 and an interpolated 8K frame 1310 in accordance with this disclosure. In this example, the interpolated frames 1300 and 1310 are generated from video of the same scene, and similar areas of each frame are highlighted for comparison. Specifically, each area 1302-1306 of the frame 1300 may be compared, respectively, to each area 1312-1316 of the frame 1310. As can be seen here, there is notable improvement in image detail in the 8K frame 1310 as compared to the 4K frame 1300.

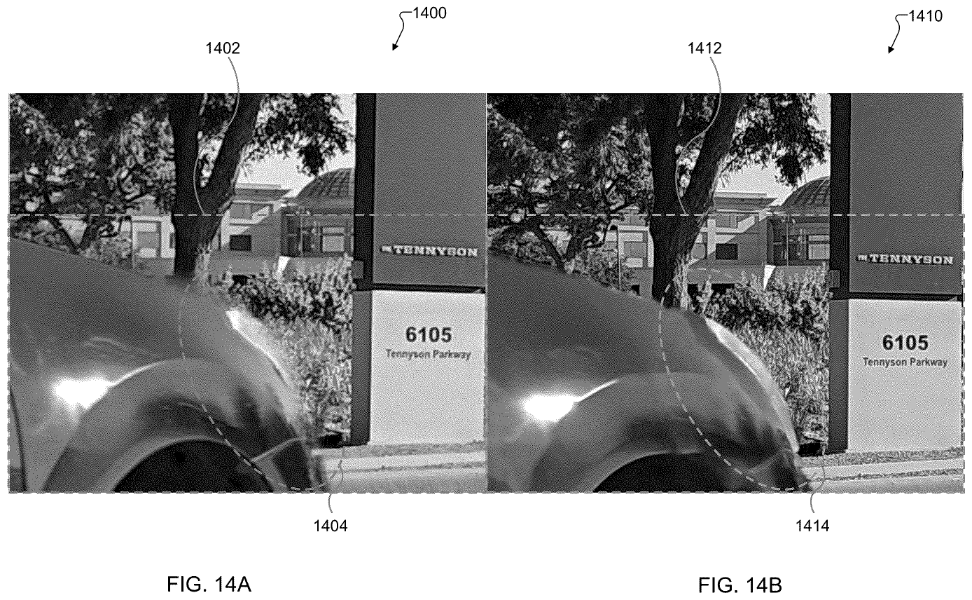

FIGS. 14A-14B illustrate an example comparison of motion artifacts between an interpolated 4K frame 1400 and an interpolated 8K frame 1410 in accordance with this disclosure. In this example, the interpolated frames 1400 and 1410 are generated from video of the same scene, and similar areas of each frame are highlighted for comparison. Specifically, each area 1402 and 1404 of the frame 1400 may be compared, respectively, to each area 1412 and 1414 of the frame 1410. As can be seen here, there is notable reduction in motion artifacts in the 8K frame 1410 as compared to the 4K frame 1400.

Although FIGS. 11-14B illustrate examples of comparisons between pixel-domain video processing and compressed-domain video processing, various changes may be made to FIGS. 11-14B. For example, the results in FIGS. 11-14B are merely meant to illustrate examples of types of benefits that might be obtained using the techniques of this disclosure. The specific results that are obtained in any given situation can vary based on the circumstances and based on the specific implementation of the techniques described in this disclosure.

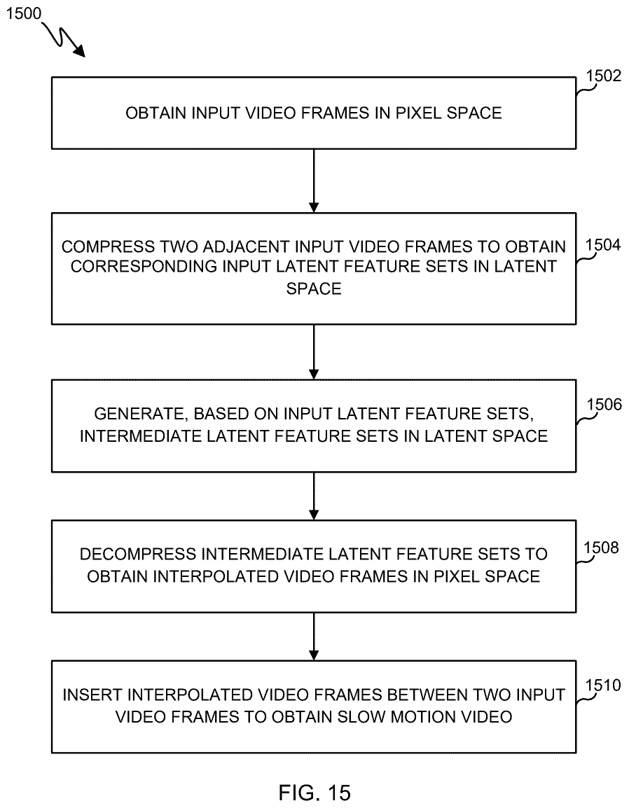

FIG. 15 illustrates an example method 1500 for compressed-domain high-resolution slow motion video processing in accordance with this disclosure. For ease of explanation, the method 1500 shown in FIG. 15 is described as being performed using the electronic device 101 in the network configuration 100 of FIG. 1, where the electronic device 101 can implement the video processing system 200 of FIG. 2. However, the method 1500 could be performed using any other suitable device(s), such as the server 106, and in any other suitable system(s).

As shown in FIG. 15, the electronic device 101 obtains input video frames in a pixel space at step 1502. In some cases, the input video frames may be 8K resolution frames, such as the input video frames 502 of FIG. 5. Also, in some cases, the input video frames may be obtained using one or more cameras or other imaging sensors 180 or the video input device 206 in the electronic device 101, obtained from a previously-recorded video stored in memory 130, or obtained in any other suitable manner.

Two adjacent input video frames are compressed to obtain corresponding input latent feature sets in a latent space at step 1504. In some embodiments, the input latent feature sets are continuous latent feature sets, and the latent space is a continuous latent space. In some cases, the processor 120 of the electronic device 101 may compress the input video frames by encoding the two input video frames using a first AI/ML model (such as the trained frame compression model 202 of FIG. 2) to obtain corresponding continuous vector representations in the continuous latent space, performing vector quantization on the continuous vector representations using the first AI/ML model to obtain corresponding discrete latent feature sets in a discrete latent space, and performing vector de-quantization on the discrete latent feature sets using the first AI/ML model to obtain corresponding continuous latent feature sets in the continuous latent space. In some cases, the processor 120 may perform the compression 504 of FIG. 5-6 using the compression system 700 of FIG. 7. The vector quantization may represent a hierarchical vector quantization on the continuous vector representations, which can be used to obtain a top-level discrete latent feature set and a bottom-level discrete latent feature set that is conditioned on the top-level discrete latent feature set for each of the continuous vector representations. Here, the processor 120 may perform the vector de-quantization by performing hierarchical vector de-quantization on each top- and bottom-level discrete latent feature set to obtain the corresponding input latent feature set.

Based on the input latent feature sets, intermediate latent feature sets are generated in the latent space at step 1506. In some cases, the processor 120 of the electronic device 101 may, for each intermediate latent feature set, estimate intermediate optical flows based on the input latent feature sets in the latent space using a second AI/ML model (such as the trained compressed-domain optical flow estimation model 203 of FIG. 2), estimate an occlusion mask based on the estimated intermediate optical flows in the latent space using a third AI/ML model (such as the trained compressed-domain occlusion mask estimation model 204 of FIG. 2), and perform frame interpolation based on the input latent feature sets, the estimated intermediate optical flows, and the estimated occlusion mask in the latent space using a fourth AI/ML model (such as the trained compressed-domain frame interpolation model 205 of FIG. 2) to generate an intermediate latent feature set. In some cases, the processor 120 may perform the optical flow estimation 504 of FIGS. 5-6 using the compressed domain optical flow estimation system 800 of FIG. 8, perform the occlusion mask estimation 508 of FIG. 5-6 using the compressed domain occlusion mask estimation system 900 of FIG. 9, and perform the frame interpolation 510 of FIG. 5-6 using the compressed domain frame interpolation system 1000 of FIG. 10.

In some embodiments, the estimated intermediate optical flows may include forward and backward intermediate optical flows. In this case, the processor 120 may estimate, using the second AI/ML model based on the input latent feature sets in the latent space, forward and backward input optical flows for the two input video frames. The processor 120 may also perform bi-linear or other interpolation on the estimated forward and backward input optical flows in the latent space to estimate the forward and backward intermediate optical flows. In addition, the processor 120 may estimate the occlusion mask from the estimated forward and backward intermediate optical flows in the latent space using a U-net AI architecture.

In some embodiments, the frame interpolation performed in the latent space using the fourth AI network can be done by warping the input latent feature set corresponding to the earlier of the two input video frames with the estimated forward intermediate optical flow to obtain a forward intermediate feature set and warping the input latent feature set corresponding to the later of the two input video frames with the estimated backward intermediate optical flow to obtain a backward intermediate feature set. The estimated occlusion mask can be applied to the forward and backward intermediate feature sets, and the fourth AI/ML model can be applied to the forward and backward intermediate feature sets to generate the intermediate latent feature set. In some cases, the processor 120 may concatenate the forward and backward intermediate feature sets after application of the estimated occlusion mask. Also, in some cases, the processor 120 may apply a NAFNet as the fourth AI/ML model to the concatenation result in order to generate the intermediate latent feature set.

The intermediate latent feature sets are decompressed to obtain interpolated video frames in the pixel space at step 1508. In some embodiments, the intermediate latent feature sets are continuous latent feature sets in the continuous latent space. In some cases, the processor 120 may decompress the intermediate latent feature sets by decoding the intermediate latent feature sets using the first AI/ML model to obtain corresponding interpolated video frames in the pixel space. In some cases, the processor 120 may perform the decompression 512 of FIG. 5-6 using the compression system 700 of FIG. 7. The interpolated video frames are inserted between the two input video frames at step 1510. Note that this can be repeated any number of times for any number of video frames to obtain a slow motion video, such as the slow motion video 514 of FIG. 5.

Although FIG. 15 illustrates one example of a method 1500 for compressed-domain high-resolution slow motion video processing, various changes may be made to FIG. 15. For example, while shown as a series of steps, various steps in FIG. 15 could overlap, occur in parallel, occur in a different order, or occur any number of times (including zero times).

It should be noted that the functions shown in or described with respect to FIGS. 2 through 15 can be implemented in an electronic device 101, 102, 104, server 106, or other device(s) in any suitable manner. For example, in some embodiments, at least some of the functions shown in or described with respect to FIGS. 2 through 15 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 15 can be implemented or supported using dedicated hardware components. In general, the functions shown in or described with respect to FIGS. 2 through 15 can be performed using any suitable hardware or any suitable combination of hardware and software/firmware instructions. Also, the functions shown in or described with respect to FIGS. 2 through 15 can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, input video frames in a pixel space;
compressing, using the at least one processing device, two adjacent input video frames to obtain corresponding input latent feature sets in a latent space;
generating, using the at least one processing device, intermediate latent feature sets in the latent space based on the input latent feature sets;
decompressing, using the at least one processing device, the intermediate latent feature sets to obtain interpolated video frames in the pixel space; and
inserting, using the at least one processing device, the interpolated video frames between the two adjacent input video frames to obtain a slow motion video.

2. The method of claim 1, wherein:
the input latent feature sets comprise continuous input latent feature sets;
the latent space comprises a continuous latent space; and
compressing the two adjacent input video frames comprises:
encoding, using a machine learning model, the two adjacent input video frames to obtain corresponding continuous vector representations in the continuous latent space;
performing, using the machine learning model, vector quantization on the continuous vector representations to obtain corresponding discrete latent feature sets in a discrete latent space; and
performing, using the machine learning model, vector de-quantization on the discrete latent feature sets to obtain corresponding continuous input latent feature sets in the continuous latent space.

3. The method of claim 2, wherein performing the vector quantization comprises performing hierarchical vector quantization on the continuous vector representations to obtain, for each of the continuous vector representations, a first-level discrete latent feature set and a second-level discrete latent feature set that is conditioned on the first-level discrete latent feature set.

4. The method of claim 3, wherein performing the vector de-quantization comprises performing hierarchical vector de-quantization on each first- and second-level discrete latent feature set to obtain the corresponding continuous input latent feature set.

5. The method of claim 2, wherein:
the intermediate latent feature sets comprise intermediate continuous latent feature sets; and
decompressing the intermediate continuous latent feature sets comprises decoding, using the machine learning model, the intermediate continuous latent feature sets to obtain corresponding interpolated video frames in the pixel space.

6. The method of claim 1, wherein generating the intermediate latent feature sets comprises:
estimating, using a first machine learning model, intermediate optical flows in the latent space based on the input latent feature sets;
estimating, using a second machine learning model, an occlusion mask in the latent space based on the intermediate optical flows; and
performing, using a third machine learning model, frame interpolation in the latent space based on the input latent feature sets, the intermediate optical flows, and the occlusion mask to generate the intermediate latent feature sets.

7. The method of claim 6, wherein:
the intermediate optical flows comprise forward and backward intermediate optical flows; and
estimating the intermediate optical flows comprises:
estimating, using the first machine learning model, forward and backward input optical flows for the two adjacent input video frames based on the input latent feature sets in the latent space; and
performing bilinear interpolation on the estimated forward and backward input optical flows in the latent space to estimate the forward and backward intermediate optical

8. The method of claim 6, wherein:
the intermediate optical flows comprise forward and backward intermediate optical flows; and
estimating the occlusion mask comprises estimating the occlusion mask from the estimated forward and backward intermediate optical flows in the latent space.

9. The method of claim 6, wherein:
the intermediate optical flows comprise forward and backward intermediate optical flows; and
performing the frame interpolation comprises:
warping the input latent feature set corresponding to an earlier of the two adjacent input video frames with the estimated forward intermediate optical flow to obtain a forward intermediate feature set;
warping the input latent feature set corresponding to a later of the two adjacent input video frames with the estimated backward intermediate optical flow to obtain a backward intermediate feature set;
applying the occlusion mask to the forward and backward intermediate feature sets; and
applying the third machine learning model to the forward and backward intermediate feature sets to generate the intermediate latent feature sets.

10. The method of claim 9, further comprising:
concatenating the forward and backward intermediate feature sets after application of the occlusion mask to generate a concatenation result;
wherein applying the third machine learning model to the forward and backward intermediate feature sets to generate the intermediate latent feature sets comprises applying a Nonlinear Activation Free Network (NAFNet) to the concatenation result to generate the intermediate latent feature sets.

11. An electronic device comprising:
at least one processing device configured to:
obtain input video frames in a pixel space;
compress two adjacent input video frames to obtain corresponding input latent feature sets in a latent space;
generate intermediate latent feature sets in the latent space based on the input latent feature sets;
decompress the intermediate latent feature sets to obtain interpolated video frames in the pixel space; and
insert the interpolated video frames between the two adjacent input video frames to obtain a slow motion video.

12. The electronic device of claim 11, wherein:
the input latent feature sets comprise continuous input latent feature sets;
the latent space comprises a continuous latent space; and
to compress the two adjacent input video frames, the at least one processing device is configured to:
encode, using a machine learning model, the two adjacent input video frames to obtain corresponding continuous vector representations in the continuous latent space;
perform, using the machine learning model, vector quantization on the continuous vector representations to obtain corresponding discrete latent feature sets in a discrete latent space; and
perform, using the machine learning model, vector de-quantization on the discrete latent feature sets to obtain corresponding continuous input latent feature sets in the continuous latent space.

13. The electronic device of claim 12, wherein, to perform the vector quantization, the at least one processing device is configured to perform hierarchical vector quantization on the continuous vector representations to obtain, for each of the continuous vector representations, a first-level discrete latent feature set and a second-level discrete latent feature set that is conditioned on the first-level discrete latent feature set.

14. The electronic device of claim 13, wherein, to perform the vector de-quantization, the at least one processing device is configured to perform hierarchical vector de-quantization on each first- and second-level discrete latent feature set to obtain the corresponding continuous input latent feature set.

15. The electronic device of claim 12, wherein:
the intermediate latent feature sets comprise intermediate continuous latent feature sets; and
to decompress the intermediate continuous latent feature sets, the at least one processing device is configured to decode, using the machine learning model, the intermediate continuous latent feature sets to obtain corresponding interpolated video frames in the pixel space.

16. The electronic device of claim 11, wherein, to generate the intermediate latent feature sets, the at least one processing device is configured to:
estimate, using a first machine learning model, intermediate optical flows in the latent space based on the input latent feature sets;
estimate, using a second machine learning model, an occlusion mask in the latent space based on the intermediate optical flows; and
perform, using a third machine learning model, frame interpolation in the latent space based on the input latent feature sets, the intermediate optical flows, and the occlusion mask to generate the intermediate latent feature sets.

17. The electronic device of claim 16, wherein:
the intermediate optical flows comprise forward and backward intermediate optical flows; and
to estimate the intermediate optical flows, the at least one processing device is configured to:
estimate, using the first machine learning model, forward and backward input optical flows for the two adjacent input video frames based on the input latent feature sets in the latent space; and
perform bilinear interpolation on the estimated forward and backward input optical flows in the latent space to estimate the forward and backward intermediate optical

18. The electronic device of claim 16, wherein:
the intermediate optical flows comprise forward and backward intermediate optical flows; and
the at least one processing device is configured to estimate the occlusion mask from the estimated forward and backward intermediate optical flows in the latent space.

19. The electronic device of claim 16, wherein:
the intermediate optical flows comprise forward and backward intermediate optical flows; and
to perform the frame interpolation, the at least one processing device is configured to:
warp the input latent feature set corresponding to an earlier of the two adjacent input video frames with the estimated forward intermediate optical flow to obtain a forward intermediate feature set;
warp the input latent feature set corresponding to a later of the two adjacent input video frames with the estimated backward intermediate optical flow to obtain a backward intermediate feature set;
apply the occlusion mask to the forward and backward intermediate feature sets; and
apply the third machine learning model to the forward and backward intermediate feature sets to generate the intermediate latent feature sets.

20. The electronic device of claim 19, wherein:
the at least one processing device is further configured to concatenate the forward and backward intermediate feature sets after application of the occlusion mask to generate a concatenation result; and
to apply the third machine learning model to the forward and backward intermediate feature sets to generate the intermediate latent feature sets, the at least one processing device is configured to apply a Nonlinear Activation Free Network (NAFNet) to the concatenation result to generate the intermediate latent feature sets.
